(19) United States
(12) Patent Application Publication
(10) Pub. No.: US 2026/0006362 A1
(43) Pub. Date: Jan. 1, 2026

(54) WIRELESS DIGITAL MICROPHONE ASSEMBLY

(71) Applicant: Sound Devices LLC, Reedsburg, WI (US)

(72) Inventors: Matthew G. Anderson, Madison, WI (US); Jason McDonald, Madison, WI (US)

(73) Assignee: Sound Devices LLC, Reedsburg, WI (US)

(21) Appl. No.: 19/252,586

(22) Filed: Jun. 27, 2025

Related U.S. Application Data
(60) Provisional application No. 63/664,854, filed on Jun. 27, 2024.

(51) Int. Cl. H04R 1/08; H04R 3/00; H04R 29/00

(52) U.S. Cl. CPC H04R 1/083; H04R 3/00; H04R 29/004; H04R 2420/07

(57) ABSTRACT

A handheld wireless microphone body may be connected to an assortment of microphone heads, providing compatibility between models from differing manufactures including accommodating differing attachment threads and electrical/audio output contact configurations without the need for hardware or software substitution. A reversible head connection adapter is fastened to the microphone body with screws. A removable main body sleeve covers push buttons for a first user interface to protect against activation by the talent when performing. A secondary user interface is covered by an interchangeable control ring which allows limited control from the exterior while the microphone is active.

### CROSS-REFERENCE TO RELATED APPLICATION

The present application claims priority of U.S. Provisional Patent Application No. 63/664,854, filed Jun. 27, 2024, the content of which is incorporated herein by reference in its entirety.

### FIELD OF THE INVENTION

The disclosed invention provides means to improve the flexibility and usability of a handheld wireless digital microphones. In one aspect, the invention allows users to switch microphone heads on the body of the wireless microphone without requiring any modifications to hardware, software or electronics. In another aspect, the invention provides accessible user interface controls that are protected from inadvertent actuation by the talent during a performance.

### BACKGROUND OF THE INVENTION

Due to the high degree of convenience and freedom of movement, the use of handheld wireless microphones has seen a dramatic increase in use over the last several years with many new products being successfully marketed. Aside from the convenience of eliminating any concerns regarding a corded connection, not all wireless microphones are created equal. While many manufacturers strive for recognition as offering the most pristine sound quality, various makes of microphone heads nonetheless provide subtle perceptible differences in directional gain pattern and/or frequency sensitivity. Aside from those attributable to the microphone head, additional differences may exist between different makes with regard to the electronics contained in the microphone body and the wireless transmitter. For example, these differences may include varying weight, bandwidth, wireless range, battery life and ornamental qualities. Some highly desirable (high performance) models of microphone heads are manufactured by Shure and Sennheiser Corp. However, these brands typically require differing thread patterns for mounting the microphone head to the microphone body along with differences in the electrical connector arrangement between the microphone head and body. Ambient Recording GmbH, Munich, DE, produces a variety of connector adapters designed to connect various microphone bodies with a head configured like a Shure head and other connector adapters designed to connect various microphone bodies with a head configured like a Sennheiser head, with other connector adapters being made for heads made by different manufactures with different threads and/or electrical connector arrangement. Unfortunately, the microphone head adapters known in the prior art are generally designed to be compatible with only one specific model or configuration of microphone head. For example, if a performer wants to switch between types of microphone head, if an adapter is needed, they most likely need to also install a different head adapter on the microphone body to provide compatible threads and electrical connector patterns for the new microphone head.

There have been instances where famous performers have invested significant sums of money to externally decorate microphone sleeves to their liking for performances, e.g. the addition of custom handles, artwork, precious gems or other decorative or functional features. Accordingly, especially in these cases, the performer may wish to use the same microphone body/sleeve assembly but switch between multiple microphone heads without any concerns involving the need for disassembly and assembly or for variations due to the electronics in the microphone body.

One aspect of the present invention provides the user (or performer) greater flexibility in selecting from a variety of microphone heads without needing to be concerned about mechanical and electrical compatibility with the head adapter or body.

Some wireless microphones do not enable the performer to control or program the microphone during use. The reasoning being that an externally accessible user input buttons or the like can be inadvertently actuated by the talent during a performance. Another aspect of the invention is directed to providing convenience in the ability to control and program the microphone before use and to provide flexibility on whether to enable the ability to control from an exterior control interface during use.

### SUMMARY OF THE INVENTION

This invention pertains to a handheld, wireless digital microphone engineered for both flexibility and robust performance. It features a main microphone body equipped with a user interface display and a primary set of control buttons located under a removable sleeve. The removable sleeve covers the microphone body, including an RF antenna and the primary set of control buttons. The sleeve is preferably constructed of non-conductive, impact resistant polycarbonate and has a window, so the display is visible from the exterior. The sleeve protects the primary set of control buttons from being accidentally pressed when the talent is performing, yet the primary set of control buttons are convenient to access by removing the sleeve. The display is preferably an epaper display with backlighting capability, thereby facilitating viewability in sunlit environments or in dark environments.

The microphone body also includes a secondary user interface. A user interface control ring, preferably situated between the top of the microphone sleeve and a head connection collar, covers the secondary user interface and provides external means to actuate the internal switch(es) of the secondary user interface. This external actuation can be achieved via exterior push buttons that press corresponding internal push buttons, or, in an alternative configuration, via a slidable magnet that interacts with a Hall sensor within the internal secondary user interface. The internal secondary user interface also preferably includes multiple LEDs adapted to output status signals. The user interface control ring includes one or more translucent windows over the LEDs to enable light from the LEDs to be viewed outside of the user interface control ring. Alternatively, the exterior buttons on the user interface collar can be made of a translucent material.

The control ring itself is preferably constructed with a rigid outer band and an inner resilient sleeve. A significant advantage is that the control ring can be interchangeable, allowing users to swap in different control rings designed to activate various combinations switches on the secondary interface. For example, the control ring can be blank with no exterior buttons or windows, thereby fully covering the secondary user interface. A first alternative can be a control-0 which includes one or more translucent windows to view the LEDs on the secondary user interface, but no exterior buttons to actuate switches on the secondary user interface. Another alternative can be a control-1 in which the control ring has one exterior button to actuate one push button on the internal secondary user interface. The exterior button can be made of a translucent material to enable viewing of the LEDs on the secondary user interface. Another alternative can be a control-3 in which the control ring has three translucent, exterior buttons to actuate three push buttons on the internal secondary user interface and enable viewing of the LEDs. If push buttons are not desirable for a given user, another alternative can be a control switch in which the secondary interface includes a Hall sensor, and the user interface control ring has a slidable magnet that can actuate the Hall sensor. This alternative preferably has a translucent window to enable viewing of the LEDs on the secondary user interface. As mentioned, each of these user control ring alternatives are interchangeable so that the extent and type of external control can be varied depending on the user and the situation. Further enhancing adaptability, the microphone features a removable microphone head connected via a removable head connection collar. The head connection collar is designed to be reversible, allowing it to mechanically connect to different types of microphone heads that have varying audio output conductor configurations (e.g., a “first type,” a “second type,” and if physically compatible a “third type”). The microphone body includes an array of spring-loaded pin connectors at its top, arranged to electrically connect with the appropriate output conductors of whichever microphone head is attached. A processor within the microphone body receives these audio signals and converts them for wireless RF transmission via the antenna. The system can determine which type of microphone head is connected, e.g., using internal analog switches. The reversible head connection collar is attached to the top of the microphone body with the selected control ring preferably between the sleeve and the collar. As mentioned, the control ring desirably has an inner resilient sleeve which provides stability to the positioning of the control ring over the secondary control buttons on the microphone body and also provides a resilient seat for the reversible head connection collar as it is attached to the top of the microphone body. Screws are desirably used to attach the reversible head connection collar to the top of the microphone body.

Although not preferred, aspects of the invention can be implemented by integrating the user interface control ring into the head connection collar. In this embodiment, the head connection collar is not reversible, however, the integrated part can be interchanged with another having a different controls to actuate the secondary user interface, or to change the threads to accommodate another microphone head.

Other embodiments and features of the invention may be apparent to those skilled in the art upon review of the drawings and the following description thereof.

### BRIEF DESCRIPTION OF THE DRAWINGS

FIGS. 1A and 1B show a handheld wireless microphone body/sleeve assembly connected to a microphone head of “Type A” in FIG. 1A and of “Type B in FIG. 1B. A reversable head connection adapter is used to accommodate the Type A microphone head shown in FIG. 1A or alternatively the Type B microphone head shown in FIG. 1B.

FIG. 2A is an assembly view showing the reversible head connection adapter and components on the handheld wireless microphone body interfacing mechanically and electrically with the reversible head connection adapter and the respective microphone head, illustrating aspects of the invention.

FIG. 2B is a detailed view of the printed circuit board (PCB) shown in FIG. 2A, which includes plug connector pins for making electrical contact with various types of microphone heads.

FIG. 2C is a table describing the functions of the pins in FIG. 2B.

FIG. 2D is flowchart illustrating the steps involved to set analog switches in response to detecting the type of microphone head attached to the wireless microphone body with the head connection adapter shown in FIGS. 1 through 4.

FIGS. 3 and 4 illustrate how the reversible head connection adapter may be removed, flipped and reconnected to accommodate an alternative microphone head illustrating aspects of the invention.

FIGS. 5A and 5B illustrate example configurations for the electrical contacts for different microphone heads, namely, annular conductor configurations for the microphone head types generically referred to as “Type A” and “Type B” throughout this application.

FIG. 6 is a diagram illustrating exemplary electrical components of a wireless microphone implementing aspects of the invention.

FIG. 7 is an assembly view of the microphone body constructed in accordance with a preferred embodiment of the invention illustrating a removable sleeve, a control ring and a microphone head connection adapter that is attached to the body using screws as the fastening means.

FIGS. 8 through 12 are partial elevation views illustrating interchangeable control rings mounted on the microphone body.

FIGS. 13 through 15 illustrate a secondary interface on the microphone body, and in FIG. 14 showing a control ring covering the secondary interface to provide limited exterior control.

FIGS. 16 through 18 are assembly drawings of different interchangeable control rings.

### DETAILED DESCRIPTION OF THE INVENTION

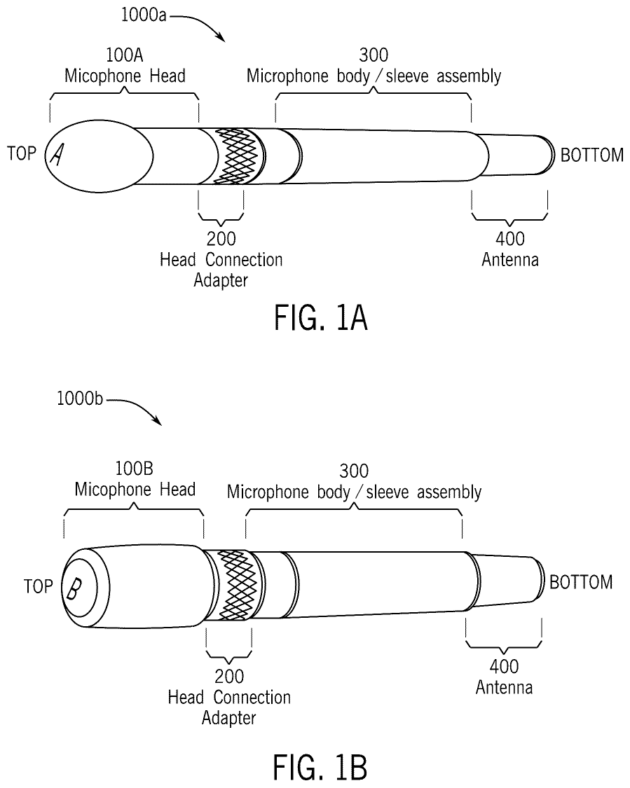

Referring to FIGS. 1A and 1B, reference numbers 1000a and 1000b refer to complete handheld wireless microphones utilizing a microphone head of Type A and Type B respectively. Both handheld wireless microphones 1000a or 1000b can generally be thought of as consisting of three (3) connected stages, including: a microphone head 100A or 100B, the head connection adapter 200, and the microphone body/sleeve assembly 300. The microphone head 100A or 100B includes one or more diaphragms and associated electronics to sense acoustic pressure. The internal electronics of the microphone head are normally responsible for many aspects of the microphone frequency response and its directionality profile.

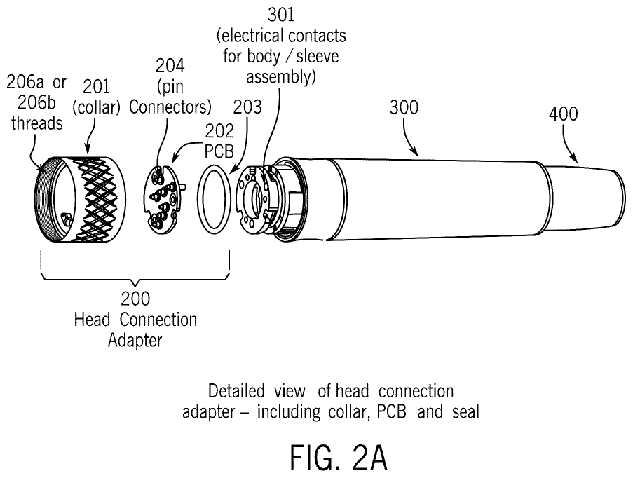

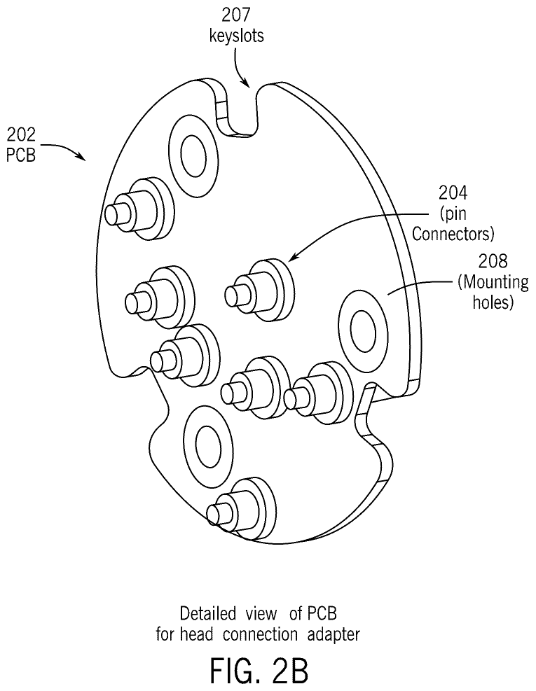

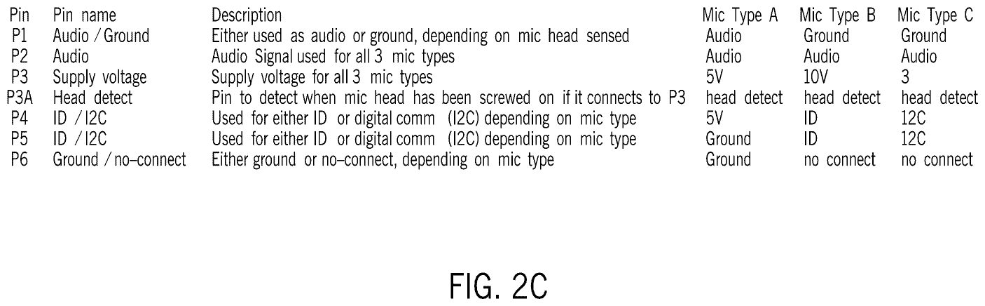

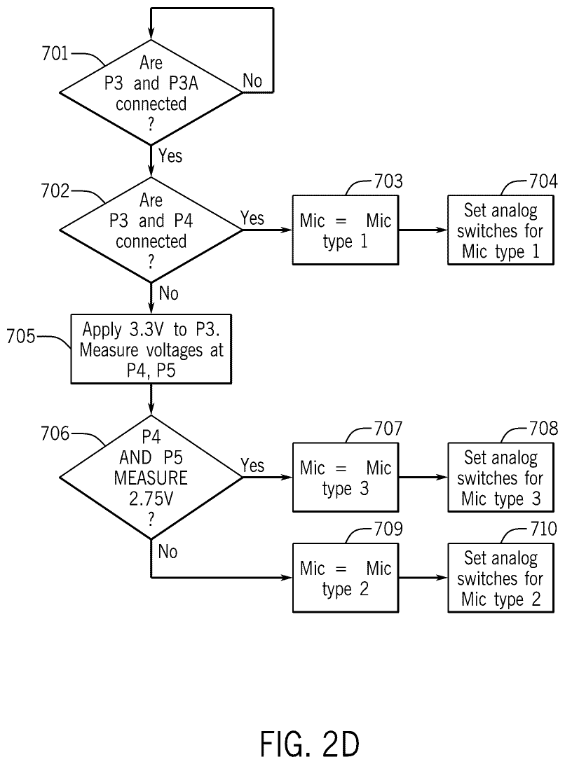

The main body 300 of the microphone 1000a, 1000b is surrounded by an outer sleeve which is removable. The main body 300 of the wireless microphone 1000a, 1000b generally includes a battery, signal amplification and analog-to-digital converting circuitry, digital signal processing and RF electronics including those for a wireless transmitter. The wireless RF transmitter antenna is located towards the bottom of the main body 300, and typically surrounded by a protective chamber 400. Referring to FIG. 2A, the sleeve around the main body 300 is the portion most conveniently held by the hand of a performer while in use. The microphone head connection adapter 200 has a reversible head adapter collar 201 that facilitates mechanical and electrical connection between the bottom of the respective microphone head 100A or 100B and the top of the main microphone body 300. In FIGS. 1-4, the main body 300 is configured to physically accommodate the reversible head connection adapter 200 and either microphone head 100A or 100B. In other words, it is contemplated that the same wireless microphone body 300 (and antenna 400) be used with the Type A microphone head 100a in FIG. 1A and the Type B microphone head 100b in FIG. 1B. The same head connection adapter 200 used in FIG. 1A is used in FIG. 1B as well. The type of interconnection for respective microphone head “Type A” or “Type B” is determined by the (up/down) orientation of the reversible collar 201 forming a part of the microphone head connection adapter 200 (see FIG. 2A).

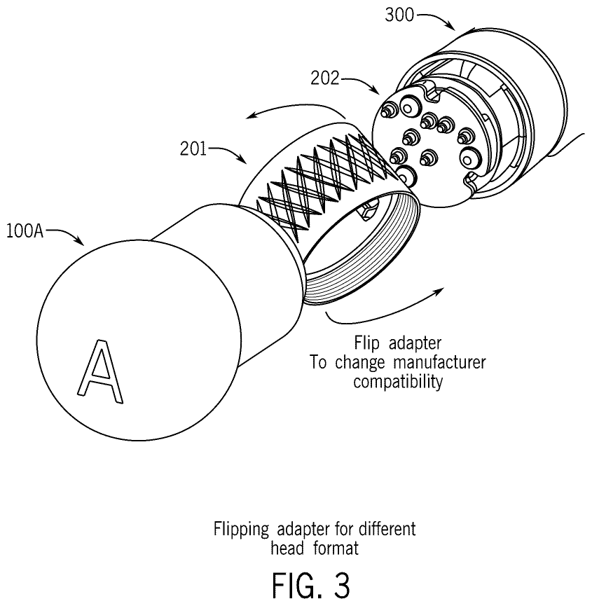

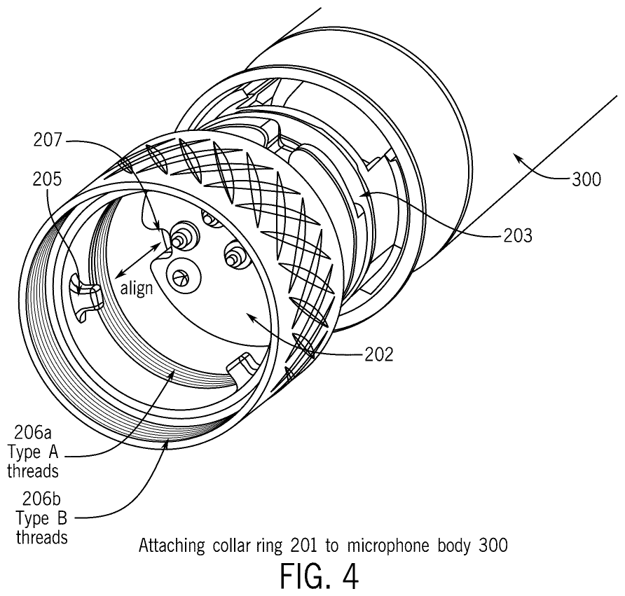

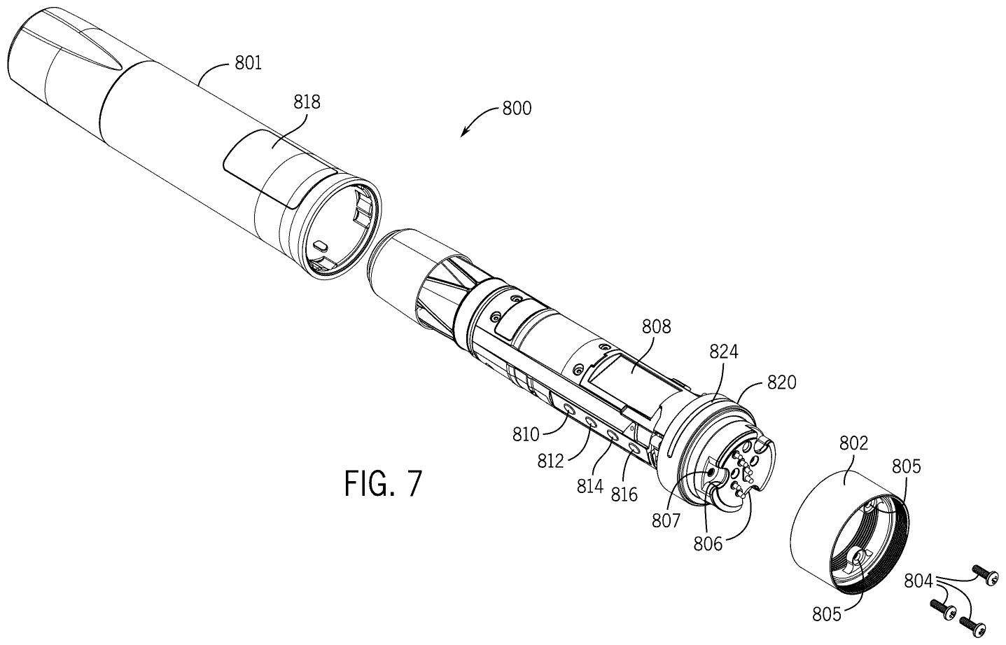

The reversible collar 201 (FIG. 2A) is configured to mount mechanically and electrically to the main body 300 of the handheld microphone and selectively to either a Type A microphone head or a Type B microphone head. In the exemplary embodiment, the reversible collar 201 has a thread size 206a compatible with the Type A microphone head 100A on one side and a thread size 206b compatible with the Type B microphone head 100B on the other side. The reversible collar 201 also has means for mechanically removably attaching the reversible collar 201 to the main body 300, such as a keyed rotational slot and compression ring 203 as shown in FIGS. 3 and 4, or via screws as shown in FIG. 7.

An array of spring-loaded pin connectors 204, e.g. on a printed circuit board (PCB) 202, are attached to the top end of the main body 300. The array of pin connectors 204 are arranged physically to receive electrical/audio signals from either the Type A or the Type B microphone heads, even though the physical configuration of the audio output conductors on the Type A microphone head are different from the physical configuration of the audio output conductors on the Type B microphone head.

The microphone heads of “Type A” 100A and “Type B” 100B (in FIGS. 1A and 1B, respectively) are assumed to have been made by differing manufacturers and are not required to be inherently electrically or mechanically cross-compatible for the purposes of this invention. However, in the exemplary embodiment of the invention, the PCB assembly 202 is attached to the main microphone body 300, and electronics in the body 300 detect whether the microphone head is a Type A or Type B microphone head and adjust the signal processing in the body 300 to be compatible with either Type A or Type B microphone heads. In this sense, a user or performer may arbitrarily select from between microphone heads 100A (Type A) or 100b (Type B) without having to substitute any remaining portions of the handheld wireless microphone apparatus.

Referring to FIGS. 2A and 2B, a compression ring 203 is fitted over the top portion of the main microphone body 300. This compression ring 203 provides a spring-like compression between the microphone body/sleeve assembly 300 and the collar ring 201 and can also provide a weather-proof seal. The PCB 202 is shown in greater detail in FIG. 2B. The PCB 202 is mounted to the top of the main body 300 such that a set of spring-loaded pin connectors 204 are mounted facing upward to make contact with the electrical contacts 101A or 101B of the microphone head, 100A or 100B, respectively. In this embodiment, the spring-loaded pin connectors 204 are product number: 0850-0-15-20-83-14-11-0 available from MillMax Manufacturing Corp. As can be seen in FIG. 2B, a series of three mounting holes 208 may be provided for fastening the PCB 202 to the top of the microphone body 300. Finally, a set of three keyslots 207 provide a pathway for the teeth 205 of the revsible connection collar 201 when the teeth 205 are slid into and fastened to the microphone body 300 in preparation of attaching a specific type of microphone head (100A or 100B).

In the disclosed embodiment, the compression ring 203 is constructed with rubber or a durable rubber-like material. Alternative embodiments include those where the compression ring 203 is constructed of flexible silicon-based material, or even based on a lightweight sealing spring/compression ring of metal made of brass, stainless steel or other suitable metal. In addition to providing a firm fit (eliminating the risk for rattling), the compression ring 203 may also provide a weather-proof seal between components to improve resilience when the handheld wireless microphone is used in wet or dusty conditions.

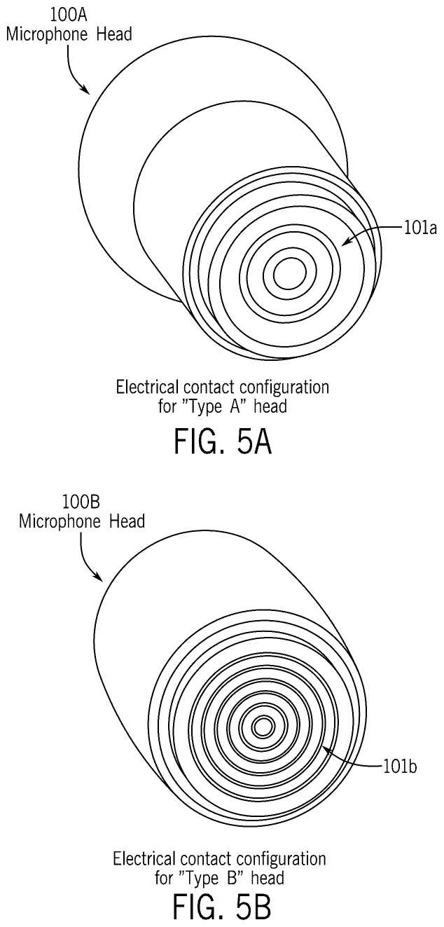

Once all the components of a microphone head connection adapter 200 (shown in FIG. 2A) are assembled, a desired microphone head may be easily attached by threading it into the mated threads 206a or 206b at the top of the connection collar 201. A salient feature is the addition of thread types 206a or 206b (Type A or Type B, respectively) that are compatible with a choice of microphone head 100A, 100B. The choice of which microphone head at this point is determined by the side (and threads) of the connection collar 201 facing upward to receive it. For purposes of this disclosure by way of example, assume that an original microphone head type (206b threads facing upward) was initially chosen as “Type B” by a user, 100b, FIG. 5B.

If at a later time, a user (or new user) desires to change microphone head type, they may do so simply by unscrewing the original (Type B) microphone head 100b, to remove it from the connection collar 201. They may then continue by disconnecting the connection collar 201 by rotating it counterclockwise (when looking down) such that the collar keys 205 are aligned with the notches 207 in the PCB 202, pulling it straight off from the PCB 202 and flipping it, as indicated (by the arrows) in FIG. 3 so the other (opposite) set of threads are now facing upward. Referring to FIG. 4, the user may then re-align the connection collar keys 205 with the notches 207 in the PCB 201, press it back down to contact the compression ring 203 and lock it in place by rotating it clockwise (looking down) until it is fully seated. At this point, the user may attach the alternate microphone head 100a (Type A) simply by screwing it into the threads provided at the top of the (now flipped) connection collar 201 and the microphone 1000a is ready for use.

Another feature is that differing electrical contact configurations 101a, 101b, such as those shown in FIGS. 5A and B for the specific cases referred to in this disclosure as “Type A” 100A and “Type B” 100B, may be accommodated. Those who are familiar with the art may wish to compare the electrical contact pattern 101a between those shown for a “Type A” 100A, microphone head 100a in FIG. 5A and those provided on many popular models of Shure™ microphone heads. Furthermore, additional insight may be gained by comparing between the electrical contact pattern 101b shown for a “Type B” 100B microphone head in FIG. 5B to those provided on several popular models of Sennheiser™ microphone heads. It should be understood that numerous additional manufacturer types may be accommodated by extending the teachings of this disclosure for the specific configuration (thread type and contact patterns) for each model.

For certain models of microphone heads, one or more pin connectors 204 on the PCB 201 may be electrically shorted together by the electrical contacts 101a or 101b when connected to a microphone head 100a or 100b. Software and hardware in the microphone body 300 may use this condition to detect (or narrow down to a subset of) specific models. Furthermore, analog switches in the microphone body 300 may be utilized to reconfigure the connectivity or purpose of various pins to prevent undesired electrical shorts and accommodate the function for a given microphone head type.

Both microphone head types referred to here (“Type A” and “Type B”) use a series of concentric annular connectors 501a and 501b positioned so that as long as the pin connectors 204 on the PCB 202 are positioned at the proper distance from the center of the PCB 202. As a microphone head is threaded into the connection collar 201, plug type electrical contacts 204 are brought into electrical (physical) contact with their corresponding electrical contacts 101a or 101b on the bottom of the microphone head, 100a or 100b, respectively. Since the microphone head contacts 101a or 101b are circular, they can maintain good contact with the spring-loaded pin connectors 204 on the PCB 202 regardless of the angular position that the head 101A or 101B arrives at (relative to the microphone body 300) due to the torque applied by the user when threading on a microphone head 100a or 100b to the connection collar portion 201 of the head connection collar 200. The pin configuration for the PCB 202 may vary depending on the types of microphone heads that the microphone body and adapter are being configured to interface with.

FIG. 2C describes the function of the pins illustrated on the PCB 202 in FIG. 2B. It is worth noting that for some embodiments, the precise position(s) for the numbered pins may depend on details for the model/construction for the microphone head being matched to those for a desired model of microphone body/sleeve assembly. There are three types of microphone heads, e.g., Type A, Type B, and Type C, in FIG. 2C. Type A and Type B require different threads for mechanical attachment as described above, but Type C needs to use the same threads as either Type A or Type B in order for the reversible collar 201 to physically attach the Type C head to the main body 300.

FIG. 2D illustrates the steps involved in setting analog switches in the microphone body in response to detecting the type of microphone head attached. Block 701 indicates that the microcontroller in the microphone body 300 starts out in a state infinitely waiting for P3A to connect to P3. This can be done either by sensing voltage or impedance. If P3A and P3 connect, then the microcontroller checks to see if P3 and P4 are connected, see block 702. This can be done either by sensing voltage or by impedance. If these pins are indeed connected, the head is determined to be Mic Type A, block 703, and analog switches in the circuit in the microphone body are configured to use the signals as shown in table in FIG. 2C for Mic Type A, block 704.

If P3 and P4 are not connected, then 3.3V is applied to the microphone at P3, block 705. The voltage at P4 and P5 are measured while a 10k pull-down resistance is applied to both pins, block 706. If 2.75 volts are detected, then this indicates that the head is a Type C head, block 707. The analog switches are then set to use the signals as shown in the chart for head Type C, block 708. Head Type C preferably has an EEPROM connected to P4 and P5. The EEPROM is read, and more information about the mic type, frequency response and other data is read about the mic capsule, and operation commences.

If P3 and P4 do not measure 2.75V, then the head is assumed to be head Type B2, block 709, and the analog switches are set accordingly, see block 710, to use the connections as shown in the table in FIG. 2C.

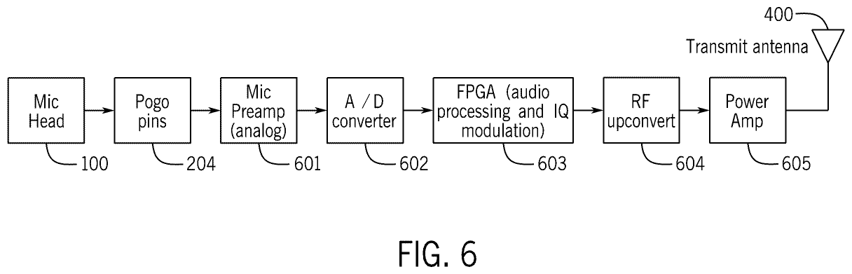

FIG. 6 illustrates exemplary electrical components of the wireless microphone showing the flow of audio data through the microphone. The microphone head 100 generates an analog audio signal which is transmitted from the head to the assigned connection pins 204 on the body of the microphone 300, in accordance with FIGS. 2C and 2D as described above. From the pins 204, the analog audio signals are amplified through an analog preamplifier 601 and then digitized by an analog-to-digital converter 602. The digitized audio signals are processed in a microcontroller which in FIG. 6 is a field programable gate array (FPGA) 603. The FPGA 603 implements audio processing and IQ modulation, e.g., as is known in the art. The processed digital output from the FPGA 604 is RF upconverted 604, amplified 605, and then transmitted to the antenna 400 for radio transmission to a receiver. Although not shown in FIG. 6, the microphone body also includes a battery and power conversion and charging electronics, as is typical in the art.

FIG. 7 is an assembly view of a microphone body 800 constructed in accordance with a preferred embodiment of the invention. The sleeve 801 is removed from the microphone body 800 in FIG. 7 but it is adapted to be slid over and attached to the microphone body 800 during normal operation. FIG. 7 shows an alternative microphone head connection adapter collar 802 that is attached to the top end the microphone body 800 using screws 804. In FIG. 7, the means for mechanically attaching the collar 802 to the top end of the main body 800 includes screw hole tabs 805 extending inward from the inside surface of the collar 802 and are spread circumferentially on the inside surface of the collar 802. The top end of the main body 800 further comprises an entry notch 806 and a screw hole 807 for each screw hole tab 805. The screws 804 pass through the screw hole tabs 805 into the respective screw hole 807 on the top end of the microphone body 800 to attach the collar 802 to the main body 800. The screws 804 can be removed and the collar 802 reversed and reattached using the screws 804 if the user would like to expose the other set of threads toward the microphone head.

Still referring to FIG. 7, removing the sleeve 801 exposes user interface buttons 810, 812, 814, 816. In this example, button 810 is the power button, which is used to power on or off, and can be configured to also implement other functions as well. The display 808 is used to display of status, settings and menus. The sleeve 801 has a window 818 so that the display 808 can be viewed when the sleeve 801 is attached and the microphone is fully assembled. The sleeve 801 is desirably made of impact absorbing polycarbonate, or another material that does not interfere with RF transmission. The sleeve 801 has a keyed latching connection to the top of the microphone body 800 to ensure that the window 818 is aligned with the display 808. The upper end of the sleeve 801 includes indexed slots to engage keys on the microphone body 800 so that the sleeve 801 attaches at a fixed rotational position onto the microphone body 800, namely, so that the window 818 on the sleeve 801 aligns with the display 808 on the microphone body 800. Buttons 812, 814, 816 are navigation buttons, namely, to navigate up or down or increase or decrease values with the middle navigation button 814 being a select button. When the microphone is in use, the sleeve 801 conceals the control buttons 810, 812, 814, 816 and protects them from being accidentally pressed during a performance. Although not shown in FIG. 7, removing the sleeve 801 exposes a battery compartment for a removable battery, a USB-C port for battery charging and communication, and a micro SD card slot for recording audio.

The display 808 is preferably an e-paper display with a controllable backlight. The home screen on the display 808 displays information such as name, frequency, battery remaining level, modulation type, RF power, record status, mute status, privacy, power off, and charging status. The displayed information persists on the e-paper display 808 even when batteries are removed. On boot-up, the display 808 preferably shows the firmware version and the fitted microphone capsule type. The display 808 incorporates a backlight that the user can use for viewing in low light conditions. The combination of the display 808 and the push buttons 810, 812, 814, 816 comprises the primary user interface on the microphone. It is also possible in the preferred embodiment to program and/or control the microphone remotely using the USB-C connection or a wireless connection.

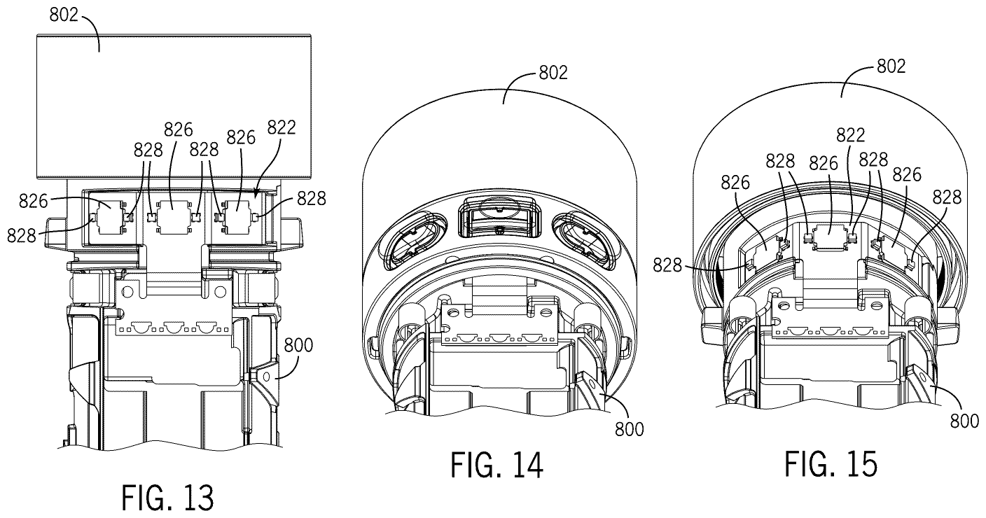

FIG. 7 also shows a control ring 820 which has a translucent lens 824 through which multicolor LEDs illuminate. The control ring 820 overlays a secondary user interface 822, see FIGS. 13-15. Referring to FIGS. 13 through 15, the secondary user interface 822 preferably includes three user input switches 826, e.g. push-button switches, that can be externally accessible depending on the control ring 820 in use and six multicolor LEDs 828 surrounding the push button switches 826 on the secondary user interface 822. Although not shown in FIGS. 13-15, the secondary interface 822 also includes a Hall sensor on the side of the microphone body 800 opposite the push button switches 826 as an alternative means to actuate the secondary user interface 822.

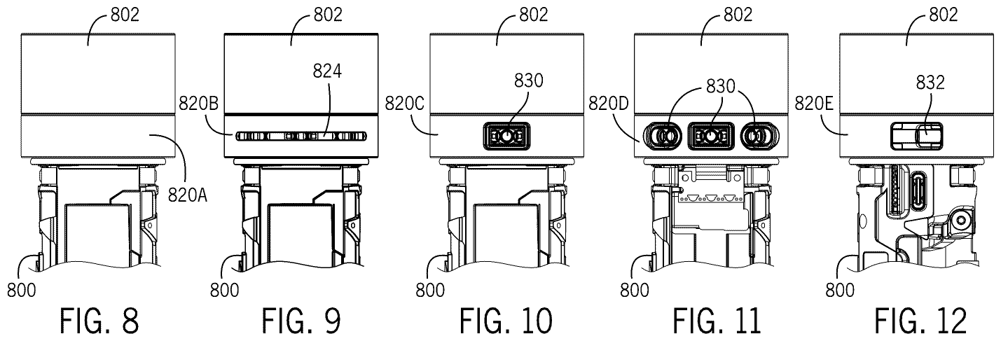

FIGS. 8 through 12 show four interchangeable control rings 824B, 824C, 824D, 824E and a blank control ring 824A, allowing the user to choose the physical buttons/switches to suit the needs at hand. FIG. 8 shows a blank control 820A that completely covers the secondary user interface 822 so that the switches 826 on the secondary user interface 822 cannot be actuated, and also so that illumination from the LEDs 828 is blocked from view. FIG. 9 shows a control ring 820B (control-0) which includes a translucent window 824, e.g. a six segment LED bar, to view the LEDs 828 on the secondary user interface 822, but no exterior buttons to actuate switches 826 on the secondary user interface 822. FIG. 10 shows another alternative control ring 820C (control-1) in which the control ring 820C has one exterior button 830 to actuate the middle push button 826 on the internal secondary user interface 822. The exterior button 830 is preferably made of a translucent material to enable viewing of the LEDs 828 on the secondary user interface 822 from the exterior of the microphone 800. FIG. 11 shows another control ring 820D (control-3) in which the control ring 820D has three translucent, exterior buttons 830 to actuate the three push buttons 826 on the internal secondary user interface 822 and enable viewing of the LEDs 828. If push buttons are not desirable for a given user, FIG. 12 shows another control ring 820E (control-sw) that has a slidable control switch 832. The secondary user interface 822 includes a Hall sensor on the side of the microphone body 800 opposite the switches 826, and the user interface control ring 820E has a slidable magnet that can actuate the Hall sensor. The control ring 820E preferably has a translucent window 824 like shown in FIG. 9 to enable viewing of the LEDs 828 on the secondary user interface 822. As mentioned, each of these control ring alternatives are interchangeable so that the extent and type of external control can be varied depending on the user and the situation. Further enhancing adaptability, the microphone features a removable microphone head connected via a removable head connection collar 802. Desirably, the switches 826, the Hall sensor and the LEDs 828 are programable to adjust the control or display functions associated with the features of the respective control ring 820A-820E. For example, the LEDs 828 can be set to provide preferred information or can be disabled when needing to be inconspicuous.

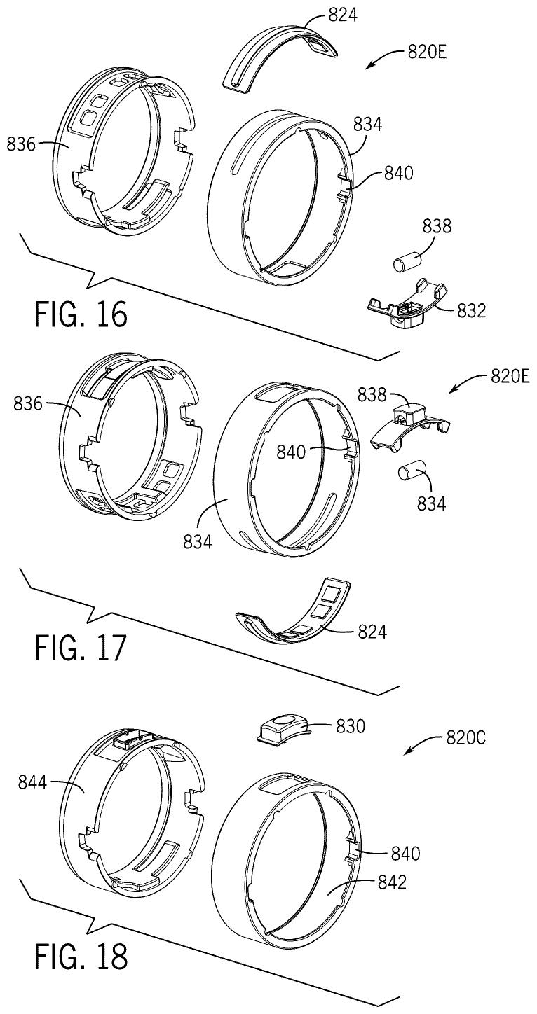

FIGS. 16 and 17 show a disassembled view of the control ring 820E with the sliding magnetic switch 832 and the translucent window 824. The control ring 820E desirably has an inner resilient sleeve 836 that provides stability to the positioning of the control ring 820E over the secondary user interface 822 on the microphone body 800 and also provides a resilient seat for the reversible head connection collar 802 as it is attached to the top of the microphone body 800. A rigid outer band 834 includes an opening for the slidable switch 832 and the magnet 838 attached to the slidable switch 832. The resilient sleeve 836 is formed and cut to accommodate the switch 832 and the LED window 824, i.e., six segment LED bar. The rigid outer band 834 also includes a pair of locating notches 840 to ensure that the control ring 820E is properly aligned on the microphone body 800.

FIG. 18 shows a disassembled view of the control ring 820C with a translucent single push button 830 as shown in FIG. 10. In this case, there is no need for an LED window 824. The control ring 820C has an inner resilient sleeve 844 and a rigid outer band 842. The resilient sleeve 844 is formed and cut to accommodate the push button 830, and the rigid outer band 842 also includes an opening for the translucent button 830 and the locating notches 840 to ensure that the control ring 820C (FIG. 11) is properly aligned on the microphone body 800. The collar ring 820D (FIG. 11) with three buttons 830 is constructed in a similar fashion.

Although this disclosure has included the use of the phrase “exemplary”, the inventors have envisioned alternative designs that are to be considered as within the scope of this disclosure. For example, other embodiments envisioned by this disclosure may include those where a series of cascaded threaded rings allow user to select a desired thread pattern to match a desired microphone head. In this disclosure a two-ended circular microphone head connection collar was featured as an exemplary embodiment. This does not limit the scope of this disclosure to such embodiments. Other embodiments could include those where a Y-shaped (or even cross-shaped or T-shaped) device could provide more than two ends for connections to be facilitated between a microphone head and handheld wireless microphone body. Further embodiments envisioned by this disclosure include those where rather than a threaded connection between a microphone head and adapter ring are present, a clip-on or snap-on or even magnetic connection mechanisms may also be suitable for some embodiments.

1. A handheld wireless microphone:
a microphone body;
a user interface display on the microphone body;
a primary set of control buttons on the microphone body;
a secondary user interface on the microphone body including one or more switches;
an RF antenna located at least in part at a bottom portion of the main body;
a removable sleeve covering the main body including the RF antenna and the primary set of control buttons, wherein the removable sleeve has a window to enable viewing of the user interface display;
a user interface control ring covering the secondary user interface on the microphone body, and including means to actuate the one or more switches of the secondary interface from an exterior of the user interface control ring.

2. The handheld wireless microphone as recited in claim 1 further comprising:
a head connection collar removably connected to a top end of the main body; and
a removable microphone head connected to the head connection collar;
wherein the user interface control ring is located between the sleeve and the head connection collar when the microphone is fully assembled.

3. The handheld wireless microphone as recited in claim 1 wherein the secondary user interface includes multiple LEDs adapted to output status signals, and the user interface control ring includes one or more translucent windows over the LEDs to enable light from the LEDs to be viewed outside of the user interface control ring.

4. The handheld wireless microphone as recited in claim 1 wherein the secondary user interface includes one or more an interior push buttons to actuate the one or more switches of the secondary user interface and said means to actuate the one or more switches of the secondary interface from an exterior of the user interface control ring includes one or more exterior buttons that can be pressed from the exterior of the user interface control ring.

5. The handheld wireless microphone as recited in claim 4 wherein the secondary user interface includes multiple LEDs adapted to output status signals, and the one or more external buttons on the user interface control ring are translucent to enable light from the LEDs to be viewed outside of the user interface control ring.

6. The handheld wireless microphone as recited in claim 4 wherein the control ring includes a rigid outer band with one or more openings and an inner resilient sleeve, and the one or more exterior buttons are mounted in the one or more openings in the rigid outer band.

7. The handheld wireless microphone as recited in claim 1 wherein the secondary user interface has three switches and three internal push buttons to actuate the three switches, and the recited control ring includes three exterior buttons that can be pressed from the exterior of the user interface control ring to actuate the respective interior push buttons and switches.

8. The handheld wireless microphone as recited in claim 7 wherein the control ring includes a rigid outer band with three openings corresponding to the location of the internal buttons on the secondary user interface and an inner resilient sleeve, and the three exterior buttons are mounted in the openings in the rigid outer band.

9. The handheld wireless microphone as recited in claim 1 wherein the one or more switches of the secondary user interface comprises a Hall sensor, and the user interface control ring includes a slidable magnet that actuates the Hall sensor from an exterior of the user interface control ring.

10. The handheld wireless microphone as recited in claim 9 wherein the secondary user interface includes multiple LEDs adapted to output status signals, and the user interface control ring includes one or more translucent windows over the LEDs to enable light from the LEDs to be viewed outside of the user interface control ring.

11. The handheld wireless microphone as recited in claim 9 wherein control ring includes a rigid outer band with an opening for the slidable magnet and an inner resilient sleeve.

12. The handheld wireless microphone as recited in claim 1 wherein the recited user interface control ring is a first user interface control ring that is interchangeable with a second user interface control ring configured to actuate a different switch or different set of switches on the secondary user interface.

13. The handheld wireless microphone as recited in claim 1 wherein the sleeve is made of a non-conductive material.

14. The handheld wireless microphone as recited in claim 2 wherein:
the head connection collar includes screw hole tabs extending inward from the inside surface of the head connection collar and spread circumferentially on the inside surface of the head connection collar, and the top end of the microphone body further comprises an entry notch and a screw hole for each screw hole tab, and screws passing through the screw hole tabs into the respective screw hole on the top end of the microphone body attach the head connection collar to the microphone body; and
the user interface control ring includes a rigid outer band and an inner resilient sleeve, and said means to actuate the one or more switches of the secondary interface from an exterior of the user interface control ring are aligned with the means for actuating the one or more switches of the secondary interface when the head connection collar is attached to the microphone body with said screws.

15. The handheld wireless microphone as recited in claim 14 further comprising:
an array of spring-loaded pin connectors attached to a top end of the microphone body, said array of pin connectors being arranged to receive electrical audio signals from at least a first type of microphone head and from a second type of microphone head, said first type of microphone head having audio output conductors in a first physical configuration, and said second type of microphone head having audio output conductors in a second physical configuration; and
processing means located within the microphone body to receive said electrical audio signals from the array of pin connectors and provide audio transmission signals to the RF antenna for wireless RF transmission;
wherein the head connection collar is reversible and includes means for mechanically attaching the collar to the said first type of microphone head, means for mechanically attaching the collar to the said second type of microphone head, and when the head connection collar is attached to the top end of the microphone body pin connectors on the top end of the microphone body connect electrically with the output connectors of the first type of microphone when the head connection collar is attached to the first type of microphone head and the pin connectors on the top end of the microphone body connect electrically with the output connectors of the second type of microphone head when the collar is attached to the second type of microphone head.

16. The handheld wireless microphone according to claim 14 wherein the means on the collar for mechanically attaching the collar to the said first type of microphone head comprises threads configured to fit threads on the first type of microphone head, and means on the collar for mechanically attaching the collar to the said second type of microphone head comprises threads configured to fit threads on the second type of microphone head.

17. The handheld microphone according to claim 14 wherein the array of pin connectors attached to the top end of the microphone body are arranged to receive electrical audio signals from a third type of microphone head, said third type of microphone head having audio output conductors in either the first physical configuration or the second configuration; and
the head connection collar is able to connect the third type of microphone head to the microphone body using either said means for mechanically attaching the collar to the said first type of microphone head or said means for mechanically attaching the collar to the said second type of microphone head.

18. The handheld wireless microphone according to claim 17 wherein the processor determines whether the first type of microphone head, the second type of microphone head or the third type of microphone head is attached by taking measurements from defined pin locations of the pin connectors.

19. The handheld microphone apparatus according to claim 17 wherein analog switches are positioned according to the determination of whether the first type of microphone head, the second type of microphone head or the third type of microphone head is attached.

20. The handheld wireless microphone according to claim 19 wherein:
the audio output conductors on said first and second type of microphone heads comprise a series of annular contacts; and
at least some of the pin connectors in the array are located at different radial distances from a center axis of the annular contacts on the first or second type of microphone heads when the respective head is attached to the collar and the top end of the microphone body.
